(19) United States
(12) Patent Application Publication
(10) Pub. No.: US 2015/0213977 A1
(43) Pub. Date: Jul. 30, 2015

(54) SWITCH

(71) Applicant: OMRON Corporation, Kyoto-shi (JP)

(72) Inventors: Yuki YAMAMOTO, Okayama-shi (JP); Makito MORII, Okayama-shi (JP); Kazuyuki TSUKIMORI, Okayama-shi (JP); Manabu TAKAHASHI, Okayama-shi (JP)

(73) Assignee: OMRON Corporation

(21) Appl. No.: 14/592,918

(22) Filed: Jan. 9, 2015

(30) Foreign Application Priority Data
Jan. 24, 2014 (JP) 2014-011587

(51) Int. Cl. H01H 19/18

(52) U.S. Cl. CPC H01H 19/18; H01H 2231/038; H01H 2221/01

(57) ABSTRACT

It is an object of the present invention to provide a switch with which heat resistance and cold resistance can both be increased inexpensively. This switch comprises a bearing member, a shaft, a manipulation member, and a switch main body. The shaft is slidably supported by the bearing member. The manipulation member is linked to the shaft. The switch main body switches a contact according to displacement of the shaft. The shaft or the bearing member includes a sliding face having a groove.

### CROSS-REFERENCES TO RELATED APPLICATIONS

This application claims priority under 35 U.S.C. §119 to Japanese Patent Application No. 2014-011587, filed on Jan. 24, 2014. The entire disclosure of Japanese Patent Application No. 2014-011587 is hereby incorporated herein by reference.

### FIELD

The present invention relates to a switch.

### BACKGROUND

There are switches with which the operation of a manipulation member is transmitted through a shaft to a switch main body (see Japanese Laid-Open Patent Application 2000-7131, for example). The shaft is supported by the bearing member, and the manipulation member is operated to move the shaft. The shaft at this point slides with respect to the bearing member. Grease or another such lubricant is packed in between the shaft and the bearing member in order to reduce the friction produced by this sliding and to give the switch better long-term durability.

### SUMMARY

It is preferable to use a lubricant with a chemically stable oil composition in order for the heat resistance and cold resistance of the switch both to reach a high level at the same time. For instance, a fluorine oil or silicon oil may be used for this lubricant. These lubricants are extremely expensive, however, and therefore are a factor in driving up the cost of the switch.

On the other hand, it is exceedingly difficult to achieve high heat resistance and cold resistance at the same time in a switch with inexpensive grease. For example, a grease with good cold resistance will generally have low viscosity, and will therefore tend to ooze out from the sliding face under a high temperature environment. Accordingly, a problem is that the oil component tends to be depleted. Also, since a grease with good heat resistance generally has high viscosity, a high starting torque is required under a low temperature environment. Therefore, poor switch return is among the problems that are encountered.

It is an object of the present invention to provide a switch with which heat resistance and cold resistance can both be increased inexpensively.

A switch according to one aspect of the present invention comprises a bearing member, a shaft, a manipulation member, and a switch main body. The shaft is slidably supported by the bearing member. The manipulation member is linked to the shaft. The switch main body switches a contact according to displacement of the shaft. The shaft or the bearing member includes a sliding face having a groove.

With the switch according to this aspect, grease accumulates in the groove of the sliding face. Therefore, even if the viscosity of the grease on the sliding face should decrease under a high temperature environment and the oil component flows out, the oil component will be resupplied from the grease in the groove. This improves the heat resistance of the switch even when an inexpensive grease is used. Also, under a low temperature environment, the groove ensures a space large enough to allow the grease to move during sliding of the bearing member and the shaft. Accordingly, compared to when the grease is held in a narrow gap between the bearing member and the shaft, deformation of the grease is easier and the sliding resistance can be reduced. This allows cold resistance to be improved even when an inexpensive grease is used. Thus, with the switch according to this aspect, both heat resistance and cold resistance can be improved inexpensively.

Preferably, the groove has a V-shaped cross section. In this case, the machining to form the groove is easier. Also, there is less of a decrease in the strength of the shaft.

Preferably, the groove has a cross sectional shape having a pair of side face components and a bottom face component that links the pair of side face components. In this case, heat resistance can be further enhanced because more grease is held in the groove. Also, enlarging the space in which the grease can move further improves cold resistance.

Preferably, the groove has a U-shaped cross section. In this case, heat resistance can be further enhanced because more grease is held in the groove. Also, enlarging the space in which the grease can move further improves cold resistance.

Preferably, the groove extends in the peripheral direction of the shaft or the bearing member. In this case, the machining to form the groove is easier.

Preferably, the sliding face has a plurality of grooves. In this case, grease can be supplied over a wider range of the sliding face.

Preferably, the plurality of grooves are equidistantly spaced. In this case, grease can be uniformly supplied over a wider range of the sliding face.

Preferably, the plurality of grooves each extend in the peripheral direction of the shaft or the bearing member. The plurality of grooves are disposed uniformly from a first end of the sliding face to a second end in the axial direction of the shaft or the bearing member. In this case, grease can be uniformly supplied over a wider range of the sliding face.

Preferably, the groove extends in a spiral shape. In this case, the machining to form the groove is easier. Also, grease can be supplied over a wider range of the sliding face.

Preferably, the manipulation member has a lever member that extends in the radial direction of the shaft. The bearing member rotatably supports the shaft. In this case, heat resistance and cold resistance are better when the shaft slides in a rotational direction with respect to the bearing member.

Preferably, the bearing member supports the shaft movably in the axial direction of the shaft. In this case, heat resistance and cold resistance are better when the shaft slides in an axial direction with respect to the bearing member.

### BRIEF DESCRIPTION OF THE DRAWINGS

FIG. 1 is an oblique view of a switch according to a first embodiment.

FIG. 2 is a II-II cross section of the switch in FIG. 1.

FIG. 3 is a simplified view of the internal configuration of the switch main body.

FIG. 4 is a side view of the shaft in the first embodiment.

FIG. 5 is a cross section of the groove of the shaft.

FIG. 6 is a cross section of the groove according to a first modification example.

FIG. 7 is a cross section of the groove according to a second modification example.

FIG. 8 is a side view of the groove according to a third modification example.

FIG. 9 is a side view of the groove according to a fourth modification example.

FIG. 10 is a side view of the groove according to a fifth modification example.

FIG. 11 is an oblique view of the switch according to a second embodiment.

FIG. 12 is a cross section of the switch according to the second embodiment.

FIG. 13 is a side view of the shaft in the second embodiment.

FIG. 14 is a cross section of the bearing member according to another embodiment.

FIG. 15 is a cross section of a modification example of the bearing member.

FIG. 16 is a cross section of a modification example of the bearing member.

FIG. 17 is a cross section of a modification example of the bearing member.

### DETAILED DESCRIPTION

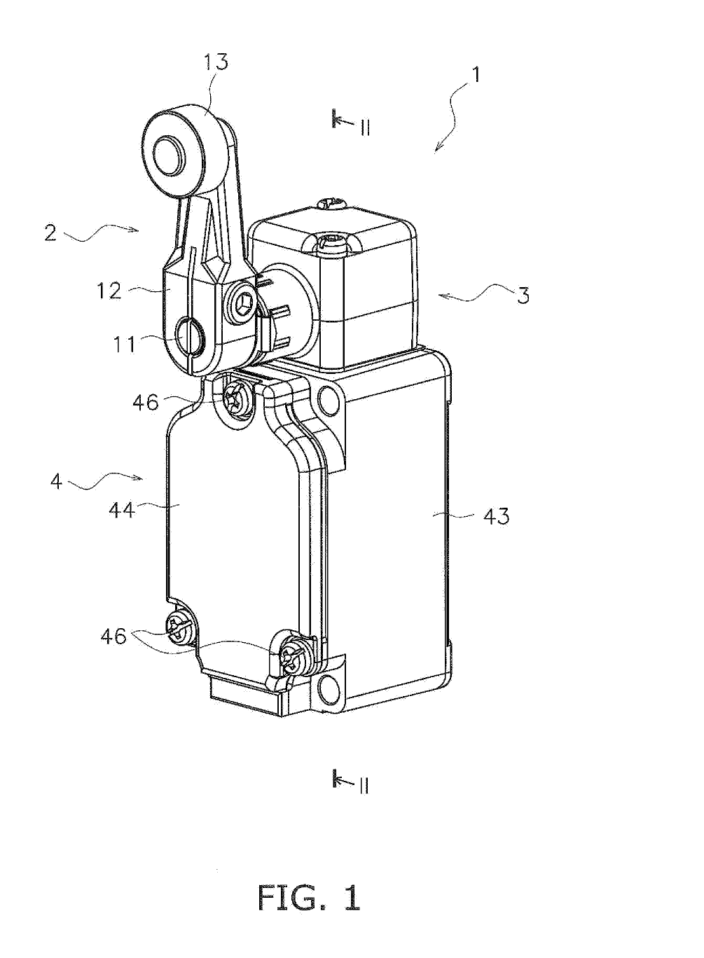

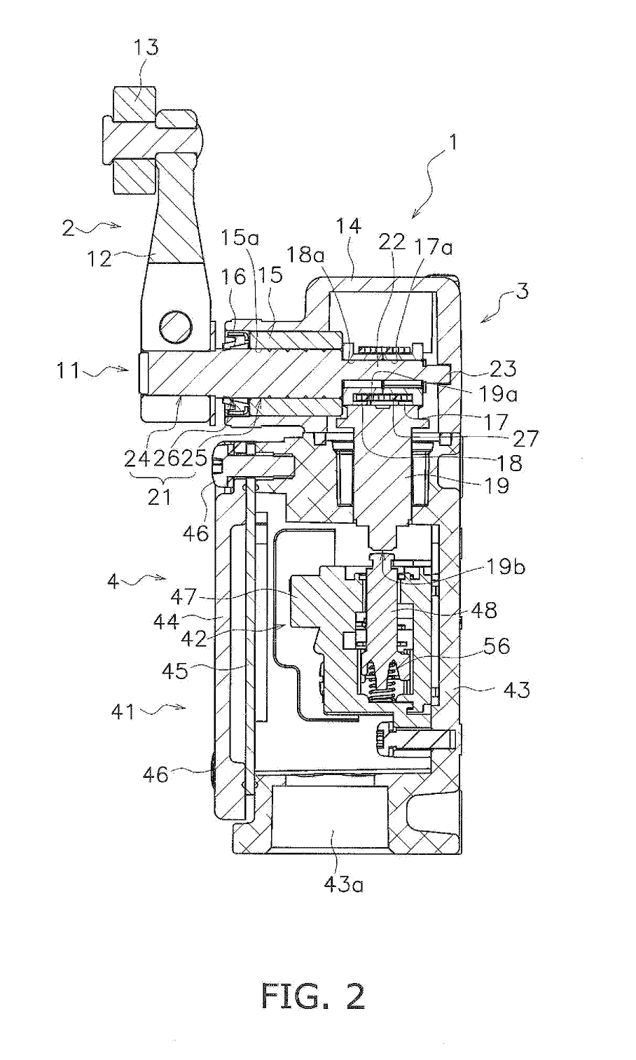

A switch according to an embodiment will now be described through reference to the drawings. FIG. 1 is an oblique view of the switch 1 according to a first embodiment. FIG. 2 is a II-II cross section of the switch 1 in FIG. 1. The switch 1 according to this embodiment is what is known as a limit switch. As shown in FIG. 1, the switch 1 has a manipulation member 2, a transmission component 3, and a main body component 4. The transmission component 3 has a shaft 11, and is linked to the manipulation member 2 via the shaft 11. The transmission component 3 is attached to the main body component 4.

The manipulation member 2 has a lever member 12 and a roller 13. The lever member 12 is in the form of a rod. The lever member 12 extends in the radial direction of the shaft 11. The roller 13 is rotatably attached to one end of the lever member 12. The shaft 11 is fixed to the other end of the lever member 12. The manipulation member 2 is provided rotatably around the axis of the shaft 11. Using the position of the manipulation member 2 shown in FIG. 1 as a neutral position, the manipulation member 2 is provided rotatably in a first direction and a second direction from the neutral position. For example, in FIG. 1, the first direction is clockwise, and the second direction is counter-clockwise.

The transmission component 3 transmits the operation of the manipulation member 2. As shown in FIG. 2, the transmission component 3 has the above-mentioned shaft 11, a transmission case 14, and a bearing member 15. The shaft 11 is supported by the transmission case 14 via the bearing member 15. The shaft 11 is slidably supported by the bearing member 15. The shaft 11 is made from stainless steel or another such metal, for example. The material of the shaft 11 is not limited to this, however.

The bearing member 15 is tubular in form. The bearing member 15 has a through-hole 15a, and the shaft 11 is inserted into the through-hole 15a. The bearing member 15 rotatably supports the shaft 11. The bearing member 15 is preferably formed from a sliding material. For instance, the bearing member 15 may be made from a copper alloy. As an example, the bearing member 15 is made from a sintered metal. The material of the bearing member 15 is not limited to these materials, however.

The shaft 11 has a first shaft component 21, a second shaft component 22, and a third shaft component 23. The first shaft component 21, the second shaft component 22, and the third shaft component 23 are aligned in the axial direction of the shaft 11. The outside diameter of the first shaft component 21 is larger than the outside diameter of the second shaft component 22. The second shaft component 22 is disposed between the first shaft component 21 and the third shaft component 23. The outside diameter of the third shaft component 23 is smaller than the outside diameter of the second shaft component 22. The first shaft component 21 protrudes from the transmission case 14, and is linked to the manipulation member 2. The second shaft component 22 and the third shaft component 23 are disposed inside the transmission case 14.

The shaft 11 has a connecting part 24, a middle part 26, and a sliding part 25. The connecting part 24, the middle part 26, and the sliding part 25 are provided to the first shaft component 21. The connecting part 24 protrudes from the transmission case 14. The connecting part 24 is connected to the manipulation member 2. The middle part 26 is located between the connecting part 24 and the sliding part 25 in the axial direction of the shaft 11. The gap between the shaft 11 and the transmission case 14 is sealed off by a sealing member 16 in the middle part 26. The sliding part 25 is disposed inside the through-hole 15a of the bearing member 15.

The transmission component 3 has a first cam 17, a second cam 18, and a plunger 19. The first cam 17 and the second cam 18 are disposed aligned in the axial direction of the shaft 11. The first cam 17 has a hole 17a. The second cam 18 has a hole 18a. The second shaft component 22 is inserted into the hole 17a of the first cam 17 and the hole 18a of the second cam 18.

The configuration is such that when the shaft 11 rotates in the first direction around its axis, the first cam 17 rotates along with the shaft 11, and the second cam 18 freewheels with respect to the shaft 11. When the shaft 11 rotates in the second direction (the opposite of the first direction), the second cam 18 rotates along with the shaft 11, and the first cam 17 freewheels with respect to the shaft 11.

The plunger 19 is disposed so that the axis of the plunger 19 is perpendicular to the axis of the shaft 11. The plunger 19 has a first end 19a and a second end 19b in the axial direction of the plunger 19. The first end 19a is disposed opposite the first cam 17 and the second cam 18. When the first cam 17 rotates along with the shaft 11, the first cam 17 presses the first end 19a in the axial direction of the plunger 19. Similarly, when the second cam 18 rotates along with the shaft 11, the second cam 18 presses the first end 19a in the axial direction of the plunger 19. When the first end 19a is pressed by the first cam 17 or the second cam 18, the second end 19b moves in the axial direction of the plunger 19.

A first return spring 27 is connected to the first cam 17 and the second cam 18. The first return spring 27 is a torsion coil spring, for example. When the first cam 17 rotates in the first direction along with the shaft 11, the first return spring 27 presses the first cam 17 in the direction of returning the first cam 17. When the second cam 18 rotates in the second direction along with the shaft 11, the first return spring 27 presses the second cam 18 in the direction of returning the second cam 18.

The main body component 4 has a main body case 41 and a switch main body 42. The main body case 41 houses the switch main body 42. The main body case 41 has a base component 43, a cover 44, and a sealing member 45. The switch main body 42 is disposed inside the base component 43. A connecting hole 43a is provided to the base component 43. The connecting hole 43a is disposed opposite the switch main body 42. The cover 44 is fixed to the base component 43 by screws 46. The space between the cover 44 and the base component 43 is sealed off by the sealing member 45.

The operation of the manipulation member 2 is transmitted through the transmission component 3 to the switch main body 42. The switch main body 42 is fixed to the base component 43. The switch main body 42 has a switch case 47 and a manipulation shaft 48. The manipulation shaft 48 protrudes from the switch case 47. The manipulation shaft 48 is disposed concentrically with the plunger 19. The contact of the switch main body 42 is switched when the manipulation shaft 48 moves in the axial direction.

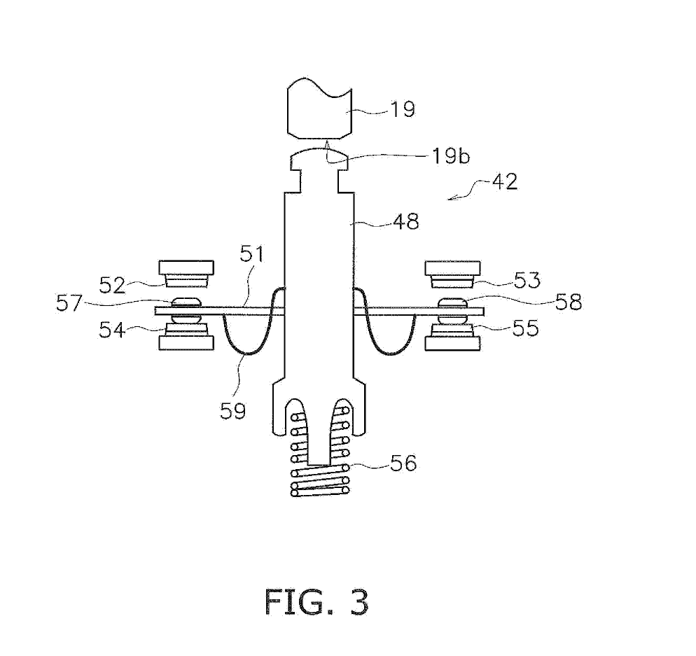

FIG. 3 is a simplified view of the internal configuration of the switch main body 42. The switch main body 42 has a movable contact arm 51, a plurality of stationary contacts 52 to 55, a second return spring 56, and a leaf spring 59. The movable contact arm 51 is linked to the manipulation shaft 48 via the leaf spring 59. The movable contact arm 51 is provided movably in the axial direction of the manipulation shaft 48 according to operation of the manipulation shaft 48. The movable contact arm 51 has a first movable contact 57 and a second movable contact 58. The switch main body 42 switches the state of these contacts (open or closed) according to movement of the manipulation shaft 48.

More precisely, the switch main body 42 has a first stationary contact 52, a second stationary contact 53, a third stationary contact 54, and a fourth stationary contact 55. The leaf spring 59 is provided so as to press the movable contact arm 51 in the opposite direction from the movement direction of the manipulation shaft 48, in the axial direction of the manipulation shaft 48. The second return spring 56 presses the manipulation shaft 48 upward in FIG. 3, so the leaf spring 59 presses the movable contact arm 51 downward in FIG. 3. That is, the second return spring 56 presses the manipulation shaft 48 so that the first movable contact 57 and the second movable contact 58 come into contact with the third stationary contact 54 and the fourth stationary contact 55, respectively. Therefore, in a state in which the plunger 19 is not pressing the manipulation shaft 48, the first movable contact 57 and the third stationary contact 54 are touching, and the second movable contact 58 and the fourth stationary contact 55 are touching (hereinafter this state will be referred to as a “first contact state”). When the plunger 19 presses the manipulation shaft 48 against the elastic force of the second return spring 56, the leaf spring 59 inverts and moves the movable contact arm 51 upward in FIG. 3. Consequently, the first movable contact 57 and the second movable contact 58 separate from the third stationary contact 54 and the fourth stationary contact 55, respectively. The first movable contact 57 then touches the first stationary contact 52, the second movable contact 58 touches the second stationary contact 53 (hereinafter this state will be referred to as a “second contact state”).

Next, the operation of the switch 1 will be described. When the manipulation member 2 is in the neutral position shown in FIG. 1, the first cam 17 and the second cam 18 are not pressing on the first end 19a of the plunger 19. Accordingly, the manipulation shaft 48 is pressed by the second return spring 56 so that the first movable contact 57 and the second movable contact 58 touch the first stationary contact 52 and the second stationary contact 53, respectively. Consequently, when the manipulation member 2 is in the neutral state, the switch main body 42 is in the first contact state.

When the roller 13 of the manipulation member 2 is subjected to an external force, the manipulation member 2 rotates around the axis of the shaft 11. For example, when the manipulation member 2 rotates in the first direction from the neutral position, the shaft 11 rotates in the first direction along with the manipulation member 2. When the first cam 17 then rotates in the first direction along with the shaft 11, the first cam 17 presses on the first end 19a of the plunger 19. Consequently, the plunger 19 moves in the axial direction, and the second end 19b of the plunger 19 presses the manipulation shaft 48 against the elastic force of the second return spring 56. As a result, the switch main body 42 is switched from the first contact state to the second contact state.

When the manipulation member 2 rotates in the second direction from the neutral position, the shaft 11 rotates in the second direction along with the manipulation member 2. Then, the second cam 18 rotates in the second direction along with the shaft 11, and the second cam 18 presses on the first end 19a of the plunger 19. Consequently, the plunger 19 moves in the axial direction, and the second end 19b of the plunger 19 presses the manipulation shaft 48 against the elastic force of the second return spring 56. As a result, the switch main body 42 is switched from the first contact state to the second contact state.

When the external force is removed from the roller 13, the elastic force of the first return spring 27 causes the shaft 11 to rotate in the reverse direction, and the manipulation member 2 goes back to the neutral position. Also, the elastic force of the second return spring 56 causes the manipulation shaft 48 to move, and the switch main body 42 returns from the second contact state to the first contact state.

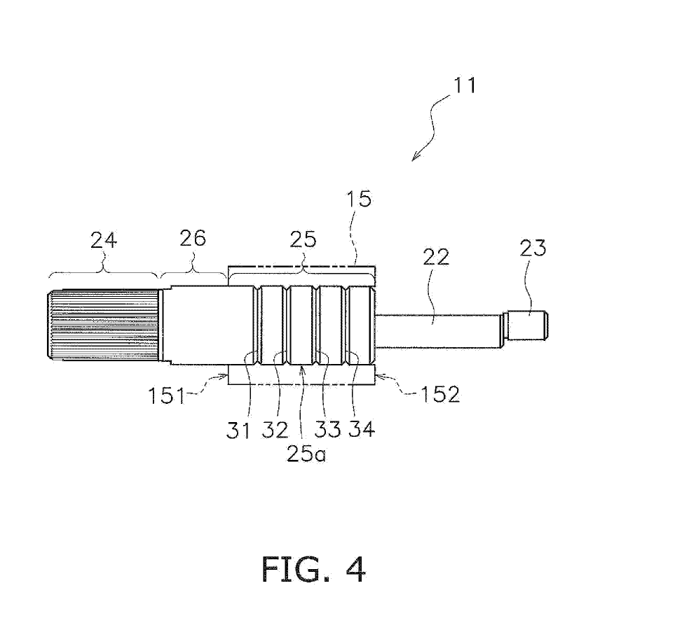

Next, the structure of the shaft 11 will be described. FIG. 4 is a side view of the shaft 11 in the first embodiment. In FIG. 4, the position of the bearing member 15 is indicated by a two-dot chain line. The bearing member 15 has a first end 151 and a second end 152 in the axial direction of the shaft 11.

As discussed above, the shaft 11 has the connecting part 24, the middle part 26, and the sliding part 25. As shown in FIG. 4, the outer peripheral face of the connecting part 24 is knurled. The middle part 26 has a smooth surface. The outer peripheral face of the sliding part 25 is a sliding face 25a that slides with respect to the inner peripheral face of the bearing member 15. More precisely, the sliding face 25a is a portion of the outer peripheral face of the shaft 11 that is located between the first end 151 and the second end 152 of the bearing member 15. The sliding face 25a generates friction with the inner peripheral face of the bearing member 15, so it is coated with grease. A plurality of grooves 31 to 34 are provided to the sliding face 25a.

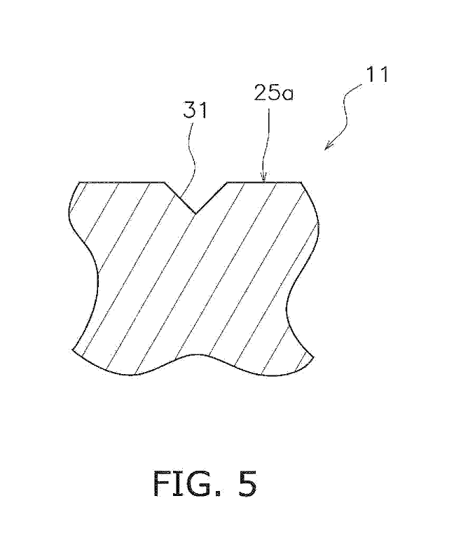

The grooves 31 to 34 each extend in the peripheral direction of the shaft 11. FIG. 5 is a detail view of the groove 31. As shown in FIG. 5, the groove 31 has a V-shaped cross section. The other grooves 32 to 34 have a V-shaped cross section the same as that of the groove 31.

The grooves 31 to 34 are spaced equidistantly in the axial direction of the shaft 11. The grooves 31 to 34 are disposed uniformly from one end of the sliding face 25a to the other in the axial direction of the shaft 11. That is, the distance between the first end 151 and the groove 31, which is the closest to the first end 151 of the bearing member 15 of all the grooves 31 to 34, is equal to the spacing between the grooves 31 to 34. Also, the distance between the second end 152 and the groove 34, which is the closest to the second end 152 of the bearing member 15, is equal to the spacing between the grooves 31 to 34. The positions of the grooves 31 to 34 are based on the centers of the grooves 31 to 34 in the axial direction of the shaft 11. In this embodiment, four grooves are provided to the sliding face 25a, but the number of grooves is not limited to four, and there may be three or fewer grooves, or there may be five or more.

As discussed above, with the switch 1 in the first embodiment, the grooves 31 to 34 are provided to the sliding face 25a of the shaft 11, and therefore, the grease that coats the sliding face 25a accumulates in the grooves 31 to 34. This means that even if the viscosity of the grease on the sliding face should decrease under a high temperature environment and the oil component flows out, the oil component will be resupplied from the grease in the grooves 31 to 34. This improves the heat resistance of the switch 1 even when an inexpensive grease is used.

Also, the viscosity of grease generally rises under a low temperature environment. Therefore, a higher torque is necessary to start the switch, and the sliding resistance increases. Moreover, relatively inexpensive grease sometimes includes lithium stearate or another such metal soap as a thickener. These metal soaps have molecules in the form of long, slender fibers, and adhere fast to metal surfaces. However, when a grease that contains such a metal soap is compressed in the narrow gap between the bearing member 15 and the shaft 11, the molecules tend to become intertwined, making deformation of the grease more difficult. As a result, a problem is that sliding resistance tends to rise under low temperature environments.

With the switch 1 according to this embodiment, however, the grooves 31 to 34 provided to the sliding face 25a ensure a space that is wide enough for the grease molecules to move around. Therefore, the grease molecules are less likely to intertwine, and the grease deforms more readily. This allows the cold resistance of the switch 1 to be enhanced even when an inexpensive grease is used.

In general, the viscosity of a grease is inversely proportional to temperature. That is, the viscosity drops at high temperatures, and rises at low temperatures. There is a “dropping point” that serves as an index of the heat resistance of a grease. The higher is the dropping point, the better the heat resistance. A problem that occurs with a switch at high temperatures is that the viscosity of the grease decreases and fluidity goes up. When fluidity goes up and the oil component flows off of the sliding face, heat and friction build up in the grease that has lost its oil component, resulting in “seizure,” so that lubrication can no longer be maintained. Therefore, a grease with high viscosity and a high dropping point is favorable for switches used in high temperature environments.

Meanwhile, there is a “pour point” that serves as an index of the cold resistance of a grease. The lower is the pour point, the better the cold resistance. A problem that is encountered with switches at low temperatures is that the viscosity of the grease rises and fluidity decreases. When fluidity decreases, there is an increase in sliding resistance, and the switch may end up taking a long time to return. Therefore, unlike grease that is favorable for high temperature environments, a grease that has low viscosity and a low pour point is favorable for switches used in low temperature environments.

As discussed above, there is a trade-off between the heat resistance and the cold resistance of a grease, and it is difficult to achieve good heat resistance and cold resistance at the same time in a single type of grease. By contrast, with the switch 1 according to this embodiment, providing the grooves 31 to 34 to the sliding face 25a allows heat resistance and cold resistance requirements to be satisfied at the same time with a single type of grease. Consequently, both heat resistance and cold resistance can be improved inexpensively.

Since the plurality of grooves 31 to 34 are provided to the sliding face 25a, grease can be supplied to a wider range of the sliding face 25a. In particular, since the grooves 31 to 34 are disposed uniformly over the sliding face 25a, grease can be supplied more evenly.

Because the grooves 31 to 34 have a V-shaped cross section, the machining for providing the grooves 31 to 34 is easy. Also, there will be less of a decrease in the strength of the shaft 11. Also, the grooves 31 to 34 extend in the peripheral direction of the shaft 11. Therefore, the machining for providing the grooves 31 to 34 can be easily carried out by cutting or the like.

The shape of the grooves 31 to 34 of the sliding face 25a is not limited to what was discussed above, and may be modified. Some modification examples of the groove shape will now be given.

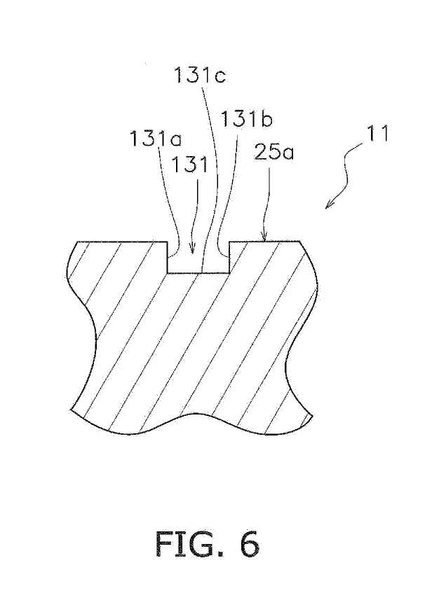

FIG. 6 is a cross section of a groove 131 according to a first modification example. The groove 131 according to the first modification example is similar to the groove 31 in the first embodiment in that it extends in the peripheral direction. However, as shown in FIG. 6, the groove 131 has a pair of side face components 131a and 131b and a bottom face component 131c that links the pair of side face components 131a and 131b. In side view, the bottom face component 131c has a linear shape. In this case, heat resistance can be further enhanced by increasing how much grease is held in the groove 131. Also, cold resistance can be further enhanced by enlarging the space in which the grease can move around.

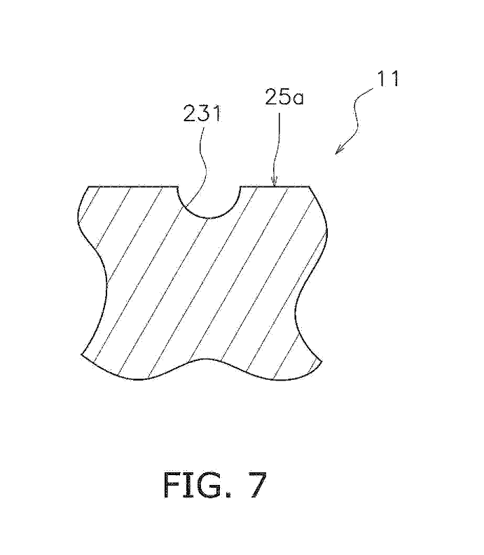

FIG. 7 is a cross section of a groove 231 according to a second modification example. The groove 231 according to the second modification example is similar to the groove 31 in the first embodiment in that it extends in the peripheral direction. However, as shown in FIG. 7, the groove 231 has a U-shaped cross section. That is, in side view, the bottom face of the groove 231 has a curved shape. In this case, heat resistance can be further enhanced by increasing how much grease is held in the groove 231 compared to a V-shaped groove. Also, cold resistance can be further enhanced by enlarging the space in which the grease can move around. Furthermore, there will be less of a decrease in strength because there are no corners in the groove 231.

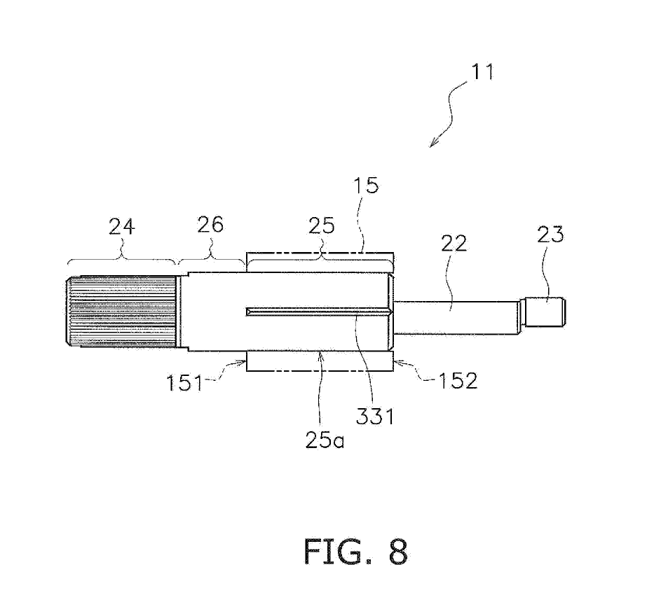

FIG. 8 is a side view of a groove 331 according to a third modification example. The groove 331 according to the third modification example extends in the axial direction of the shaft 11. The groove 331 is provided over the entire sliding face 25a in the axial direction of the shaft 11. In FIG. 8 only one groove 331 is shown, but instead of the groove 331, a plurality of grooves extending in the axial direction of the shaft 11 may be disposed spaced apart in the peripheral direction of the shaft 11. In this case, the grooves extending in the axial direction of the shaft 11 are preferably disposed equidistantly spaced in the peripheral direction of the shaft 11.

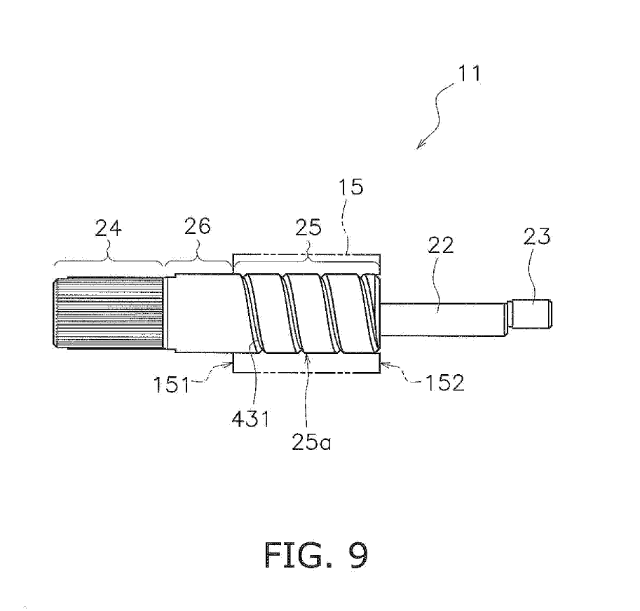

FIG. 9 is a side view of a groove 431 according to a fourth modification example. The groove 431 in the fourth modification example extends in a spiral shape.

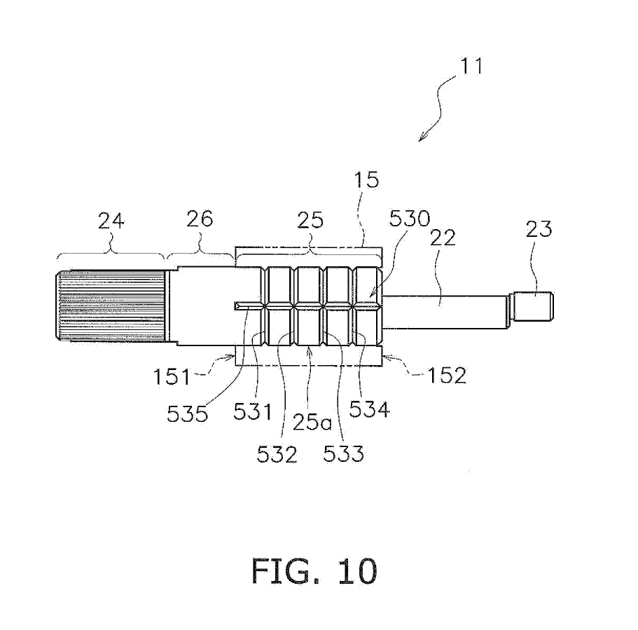

FIG. 10 is a side view of a groove 530 according to a fifth modification example. The groove 530 according to the fifth modification example has grooves 531 to 534 extending in the peripheral direction of the shaft 11, and a groove 535 extending in the axial direction of the shaft 11. In FIG. 10, only one groove 535 is shown extending in the axial direction of the shaft 11, but the groove 530 according to the fifth modification example may have a plurality of grooves extending in the axial direction of the shaft 11.

The grooves 331, 431, and 530 according to modification examples 3 to 5 each have a V-shaped cross section, but may instead have a cross section that is other than V-shaped, as in the groove 131 of the first modification example or the groove 231 of the second modification example.

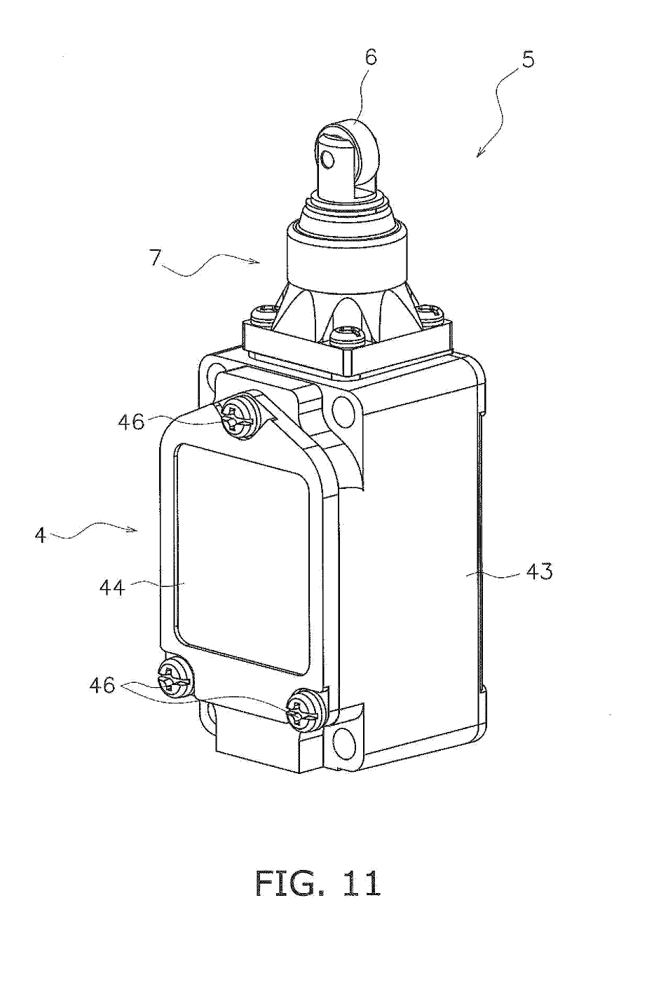

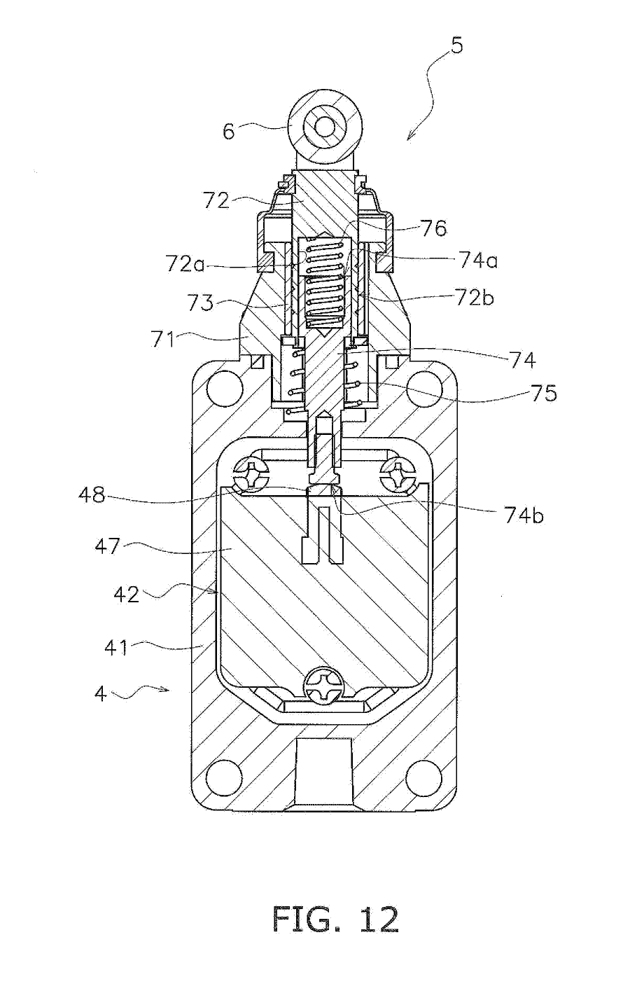

Next, a switch 5 according to a second embodiment will be described. FIG. 11 is an oblique view of the switch 5 according to the second embodiment, and FIG. 12 is a cross section of the switch 5 according to the second embodiment. The switch 5 has a manipulation member 6, a transmission component 7, and a main body component 4. The manipulation member 6 is a roller. The transmission component 7 transmits the operation of the manipulation member 6 to the main body component 4. The main body component 4 is configured the same as the main body component 4 in the first embodiment above. Therefore, components that are the same as in the main body component 4 in the first embodiment will be numbered the same and will not be described in detail again.

The transmission component 7 has a transmission case 71, a shaft 72, a bearing member 73, and an auxiliary shaft 74. The manipulation member 6 is rotatably attached to one end of the shaft 72. A hole 72a extending in the axial direction of the shaft 72 is provided to the other end of the shaft 72. The shaft 72 is supported by the transmission case 71 via the bearing member 73. The bearing member 73 supports the shaft 72 movably in the axial direction of the shaft 72. The shaft 72 is supported by the main body case 41 via a first return spring 75.

The auxiliary shaft 74 is aligned with the axial direction of the shaft 72. The auxiliary shaft 74 is disposed concentrically with the shaft 72. The auxiliary shaft 74 has a first end 74a and a second end 74b. The first end 74a of the auxiliary shaft 74 is disposed inside the hole 72a of the shaft 72. The auxiliary shaft 74 is provided movably in the axial direction of the shaft 72. The second end 74b of the auxiliary shaft 74 is opposite the manipulation shaft 48. A second return spring 76 is disposed between the auxiliary shaft 74 and the shaft 72. The second return spring 76 is disposed inside the hole 72a of the shaft 72.

In FIGS. 11 and 12, the manipulation member 6 is located in the neutral position. In a state in which no external force is being exerted on the manipulation member 6, the manipulation member 6 is located in the neutral position. In this case, the switch main body 42 is in the first contact state. When an external force is exerted on the manipulation member 6, the shaft 72 moves in the axial direction of the shaft 72 against the elastic force of the first return spring 75. The movement of the shaft 72 in the axial direction is transmitted to the auxiliary shaft 74, and the auxiliary shaft 74 moves in the axial direction of the shaft 72. Consequently, the second end 74b of the auxiliary shaft 74 presses on the manipulation shaft 48. As a result, the switch main body 42 is switched from the first contact state to the second contact state.

When the external force on the manipulation member 6 is released, the shaft 72 moves in the reverse direction under the elastic force of the first return spring 75, and the manipulation member 6 returns to the neutral position. Just as in the first embodiment above, the switch main body 42 returns from the second contact state to the first contact state when the manipulation shaft 48 moves.

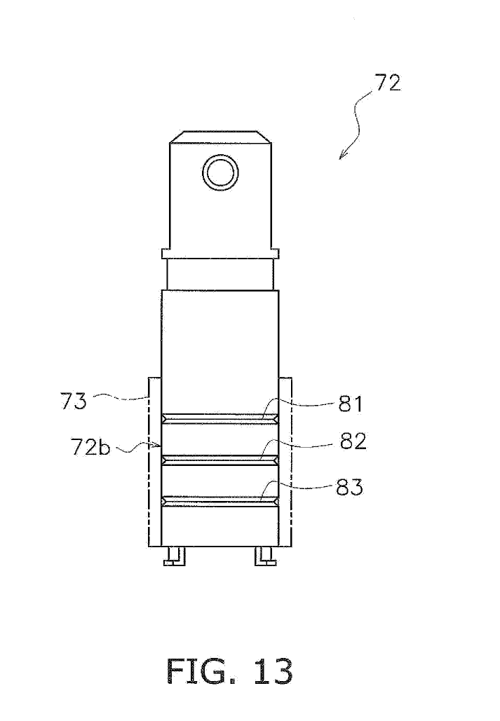

The shaft 72 according to the second embodiment is similar to the shaft 11 in the first embodiment in that it has a sliding face 72b provided with grooves. FIG. 13 is a side view of the shaft 72 in the second embodiment. In FIG. 13, the position of the bearing member 73 in the neutral position is indicated by a two-dot chain line. Grooves 81 to 83 are provided to the sliding face 72b of the shaft 72. In this embodiment, three grooves (81 to 83) are provided to the sliding face 72b. The grooves 81 to 83 have a V-shaped cross section. The grooves 81 to 83 extend in the peripheral direction of the shaft 72. The grooves 81 to 83 are equidistantly spaced, and are disposed uniformly over the sliding face 72b with the bearing member 73.

The form of the grooves 81 to 83 is not limited to what is shown in FIG. 13, and may be the same form as that of the grooves according to any of the first to fifth modification examples discussed above.

Embodiments of the present invention were described above, but the present invention is not limited to or by these embodiments, and various modifications are possible without departing from the gist of the invention.

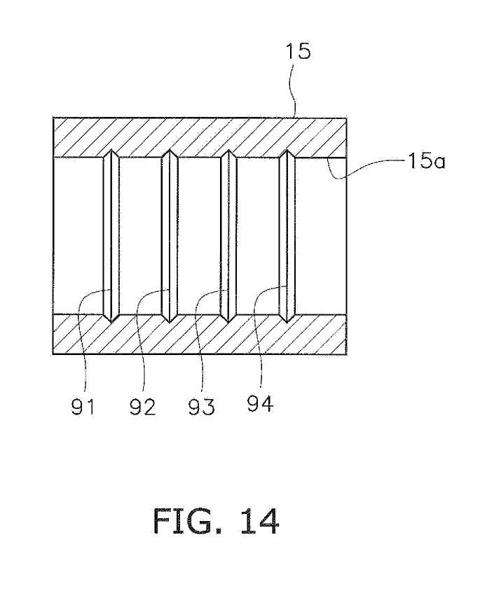

In the above embodiments, the shaft had a sliding face provided with grooves, but the bearing member may instead have a sliding face provided with grooves. That is, as shown in FIGS. 14 to 17, grooves may be provided to the sliding face of the bearing member 15 (the inner peripheral face of the through-hole 15a).

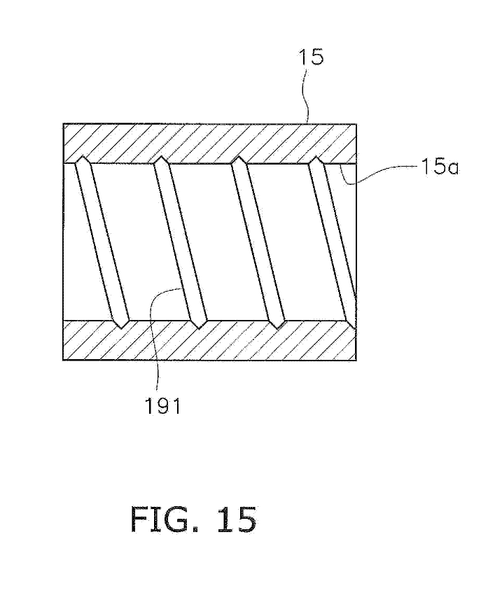

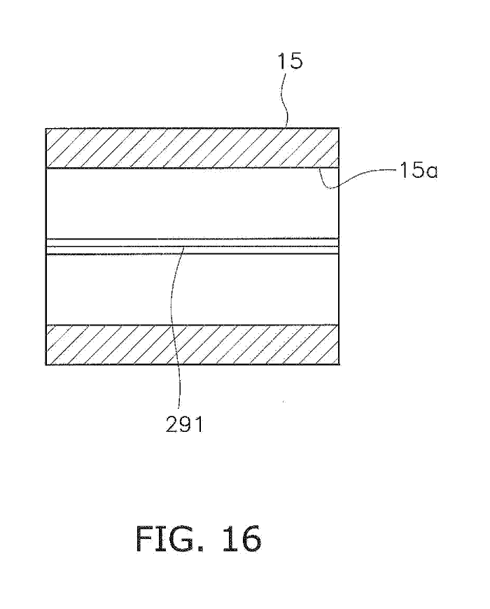

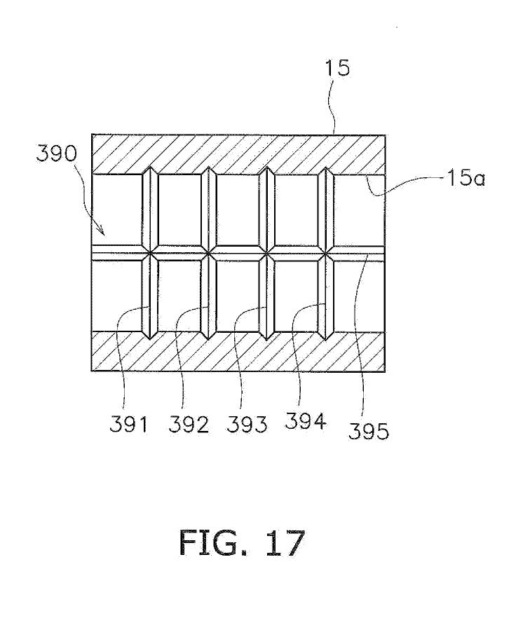

As shown in FIG. 14, for example, a plurality of grooves 91 to 94 extending in the peripheral direction of the bearing member 15 may be provided to the sliding face of the bearing member 15. Alternatively, as shown in FIG. 15, a spiral groove 191 may be provided to the sliding face of the bearing member 15. Alternatively, as shown in FIG. 16, a groove 291 extending in the axial direction of the bearing member 15 may be provided to the sliding face of the bearing member 15. Alternatively, as shown in FIG. 17, groove 390 may be provided to the sliding face of the bearing member 15. The grooves 390 has a plurality of grooves 391 to 394 extending in the peripheral direction of the bearing member 15, and a groove 395 extending in the axial direction of the bearing member 15.

Just as with the grooves in the sliding face of the shaft discussed above, the number and layout of the grooves in the sliding face of the bearing member 15 are not limited to what is shown in FIGS. 14 to 17. Also, the cross sectional shape of the various grooves of the bearing member 15 is not limited to a V shape, just as with the cross sectional shape of the various grooves of the shaft.

In the above embodiments, a limit switch was used as an example, but the present invention may be applied to some switch other than a limit switch.

In the above embodiments, a plurality of grooves were disposed equidistantly spaced apart, but may instead be disposed at uneven intervals. In the above embodiments, a plurality of grooves were disposed uniformly over the sliding face, but may instead be disposed unevenly.

1. A switch, comprising:
a bearing member;
a shaft slidably supported by the bearing member;
a manipulation member linked to the shaft; and
a switch main body configured to switch a contact according to a displacement of the shaft,
wherein the shaft or the bearing member includes a sliding face having a groove.

2. The switch according to claim 1,
wherein the groove has a V-shaped cross-section.

3. The switch according to claim 1,
wherein the groove has a cross-sectional shape having a pair of side face components and a bottom face component that links the pair of side face components.

4. The switch according to claim 1,
wherein the groove has a U-shaped cross-section.

5. The switch according to claim 1,
wherein the groove extends in a peripheral direction of the shaft or the bearing member.

6. The switch according to claim 1,
wherein the sliding face has a plurality of grooves.

7. The switch according to claim 6,
wherein the plurality of grooves are equidistantly spaced.

8. The switch according to claim 6,
wherein the plurality of grooves each extend in the peripheral direction of the shaft or the bearing member, and
the plurality of grooves are disposed uniformly from a first end of the sliding face to a second end of the sliding face in an axial direction of the shaft or the bearing member.

9. The switch according to claim 1,
wherein the groove extends in a spiral shape.

10. The switch according to claim 1,
wherein the manipulation member has a lever member extending in a radial direction of the shaft, and
the bearing member rotatably supports the shaft.

11. The switch according to claim 10,
wherein the sliding face has a plurality of grooves.

12. The switch according to claim 11,
wherein the plurality of grooves are equidistantly spaced.

13. The switch according to claim 11,
wherein the plurality of grooves each extend in the peripheral direction of the shaft or the bearing member, and
the plurality of grooves are disposed uniformly from a first end of the sliding face to a second end of the sliding face in an axial direction of the shaft or the bearing member.

14. The switch according to claim 1,
wherein the bearing member supports the shaft movably in the axial direction of the shaft.

15. The switch according to claim 14,
wherein the sliding face has a plurality of grooves.

16. The switch according to claim 15,
wherein the plurality of grooves are equidistantly spaced.

17. The switch according to claim 15,
wherein the plurality of grooves each extend in the peripheral direction of the shaft or the bearing member, and
the plurality of grooves are disposed uniformly from a first end of the sliding face to a second end of the sliding face in an axial direction of the shaft or the bearing member.
